(19) United States
(12) Patent Application Publication
(10) Pub. No.: US 2009/0221418 A1
(43) Pub. Date: Sep. 3, 2009

(54) METHOD FOR PRODUCTION OF HIGHLY-ACTIVE METAL/METAL OXIDE CATALYSTS

(75) Inventors: Richard Fischer, Bad Aibling (DE); Arnold Tissler, Tegernheim (DE); Roland Fischer, Bochum (DE); Stephan Hermes, Bochum (DE); Martin Muhler, Bochum (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 12/063,047

(22) PCT Filed: Jul. 25, 2006
(86) PCT No.: PCT/EP2006/007336

§ 371 Date: Feb. 12, 2009

(30) Foreign Application Priority Data
Aug. 10, 2005 (DE) 10 2005 037 893.5

(51) Int. Cl. B01J 31/12; B01J 31/02

(52) U.S. Cl. 502/155; 502/152; 977/773

(57) ABSTRACT

The invention relates to a process for producing a catalyst comprising a porous support and at least one active metal, which comprises
providing a porous support which has a specific BET surface area of at least 500 m²/g and is transparent to an activating radiation,
applying at least one active metal precursor which comprises at least one active metal and at least one group which is bound via a ligator atom selected from among oxygen, sulfur, nitrogen, phosphorus and carbon to the active metal atom to the porous support so as to produce an adduct which comprises the porous support and the at least one active metal precursor; and
illuminating the adduct with the activating radiation to convert the at least one active metal into its reduced form.

The invention relates to a process for producing a catalyst, a catalyst which can be obtained by the process and also its use.

Cu/ZnO systems, which are usually supplemented by Al₂O₃, are used as catalysts for the industrial synthesis of methanol. These catalysts are produced on a large scale by precipitation reactions. Here, copper and zinc act as catalytically active substances, while a thermostabilizing action as structural promoter is ascribed to the aluminum oxide. The atomic ratios of copper to zinc can vary, but the copper is generally present in excess.

Such catalysts are known, for example, from DE-A-2 056 612 and from U.S. Pat. No. 4,279,781. A corresponding catalyst for the synthesis of methanol is also known from EP-A-0 125 689. This catalyst is characterized in that the proportion of pores having a diameter in the range from 20 to 75 Å is at least 20% and the proportion of pores having a diameter of more than 75 Å is not more than 80%. The Cu/Zn atomic ratio is in the range from 2.8 to 3.8, preferably from 2.8 to 3.2, and the proportion of Al₂O₃ is from 8 to 12% by weight.

A similar catalyst for the synthesis of methanol is known from DE-A-44 16 425. It has an atomic ratio of Cu/Zn of 2:1 and generally comprises from 50 to 75% by weight of CuO, from 15 to 35% by weight of ZnO and in addition contains from 5 to 20% by weight of Al₂O₃.

Finally, EP-A-0 152 809 discloses a catalyst for the synthesis of alcohol mixtures comprising methanol and higher alcohols which in the form of an oxidic precursor comprises (a) copper oxide and zinc oxide, (b) aluminum oxide as thermostabilizing substance and (c) at least one alkali metal carbonate or alkali metal oxide, wherein the oxidic precursor has a proportion of pores having a diameter in the range from 15 to 7.5 nm of from 20 to 70% of the total volume, the alkali contents is from 13 to 130×10⁻⁶ per gram of the oxidic precursor and the aluminum oxide component has been obtained from a colloidally dispersed aluminum hydroxide (aluminum hydroxide sol or gel).

In the processes used hitherto for producing catalysts for the synthesis of methanol, the support is laden with appropriate precursor compounds of the catalytically active metals and then usually subjected to a plurality of oxidative and/or reductive preparation steps, usually using air or oxygen as oxidizing agent and hydrogen as reducing agent, at relatively high temperatures. In addition, these processes usually encompass a plurality of calcination steps, typically at 250-400° C. In these process steps, particle growth of the catalytically active reaction sites occurs and leads to a reduction in the catalytic activity.

The Cu/ZnO system is the basis of the industrial synthesis of methanol and an important component of fuel cell technology (reformer). It is the prototype for the study of synergetic metal/support interactions in heterogeneous catalysis [P. L. Hansen, J. B. Wagner, S. Helveg, J. R. Rostrup-Nielsen, B. S. Clausen, H. Topsøe, M. Science 2002, 295, 2053-2055]. Studies using high-resolution in-situ transmission electron microscopy (TEM) thus covered dynamic shape changes of ZnO-supported Cu nanocrystallites (2-3 nm) as a function of the redox potential of the gas phase. Under the reducing conditions (H₂/CO) of the methanol synthesis, the Cu particles are flattened with considerably increased wetting of the ZnO support. In addition, there is a positive correlation between the degree of stressing of ZnO-supported Cu nanoparticles and the catalytic activity. The formation of Cu/Zn alloys is also of importance, as the promotion of Cu(111) surfaces as a result of Zn deposition demonstrates.

Zeolites and zeolite-like structures, e.g. mordenite, VPI-5 or cloverite, and also periodic mesoporous silicate minerals (PMS) such as MCM-41, MCM-48 or SBA-15 have proven to be excellent supports for many catalytically active species because of their very high specific surface areas and the pore structure which can be set precisely in the low nm range and Cu/PMS or CuOₓ/PMS materials in particular have been examined intensively. However, these Cu/PMS or CuOₓ/PMS materials are inactive or significantly less active in respect of the synthesis of methanol [K. Hadjiivanov, T. Tsoncheva, M. Dimitrov, C. Minchev, H. Knozinger, “Characterization of Cu/MCM-41 and Cu/MCM-48 mesoporous catalysts by FTIR spectroscopy of adsorbed CO”, Applied Catalysis A-General 2003, 241, 331] and do not contain the ZnO component.

The loading of PMS with metals and metal oxides by metal organic chemical vapor deposition is known for a few metals, e.g. for Au [M. Okumura, S. Tsubota, M. Iwamoto, M. Haruta, “Chemical vapor deposition of gold nanoparticles on MCM-41 and their catalytic activities for the low-temperature oxidation of CO and of H₂”, Chemistry Letters 1998, 315] or Pd [C. P. Mehnert, D. W. Weaver, J. Y. Ying, “Heterogeneous Heck catalysis with palladium-grafted molecular sieves”, Journal of the American Chemical Society 1998, 120, 12289] and for Al₂O₃ [A. M. Uusitalo, T. T. Pakkanen, M. Kroger-Laukkanen, L. Niinisto, K. Hakala, S. Paavola, B. Lofgren, “Heterogenization of racemic ethylenebis(1-indenyl)zirconium dichloride on trimethylaluminum vapor modified silica surface”, Journal of Molecular Catalysis A-Chemical 2000, 160, 343].

It was an object of the invention to provide a process for producing catalysts, in particular for the synthesis of methanol, by means of which catalysts having a very high activity can be obtained.

This object is achieved by a process having the features of claim 1. Advantageous embodiments of the process of the invention are subject matter of the dependent claims.

The invention provides a process for producing a catalyst comprising a porous support and at least one active metal, which comprises
providing a porous support which has a specific BET surface area of at least 500 m²/g and is transparent to an activating radiation,
applying at least one active metal precursor which comprises at least one active metal and at least one group which is bound via a ligator atom selected from among oxygen, sulfur, nitrogen, phosphorus and carbon to the active metal atom and can be eliminated by means of the activating radiation to the porous support so as to produce an adduct which comprises the porous support and the at least one active metal precursor; and
illuminating the adduct with the activating radiation to liberate the active metal.

In the process of the invention, the active metal is liberated from the active metal precursor by illumination with an activating radiation, i.e. under extremely mild conditions. The liberation is preferably carried out at room temperature or at temperatures below room temperature. In this way, the active metal can be deposited in the form of very small particles on the surface of the porous support. As a result of the low thermal stress during the liberation, virtually no growth of the active metal particles takes place and a very high specific surface area of the active metal and thus a very high activity of the catalyst produced by the process of the invention are obtained.

The process of the invention is carried out by firstly providing a porous support having a very high specific surface area of at least 500 m²/g. Furthermore, the porous support is selected so that it is transparent to the activating radiation.

For the purposes of the present invention, a transparent support is a support whose transmittance for the activating radiation is sufficiently high for even interior regions of the support, for example a particle of the support material, to be able to be reached by the activating radiation in a sufficient intensity to be able to effect conversion of the active metal precursor. Thus, it is not necessary for the support to be completely or at least virtually completely transparent to the activating radiation. It is merely necessary for the activating radiation to be absorbed by the support material only to such an extent that liberation of the active metal can occur in the entire volume of the support. The material of the support is therefore selected as a function of the activating radiation used. For the purposes of the invention, a transparent support is preferably a support which in a layer of 1 mm attenuates the intensity of the activating radiation by preferably not more than 70%, in particular not more than 50%.

The activating radiation is in turn selected as a function of the active metal precursor used. The activating radiation is selected so that it can effect liberation of the active metal from the active metal precursor. A suitable activating radiation can be determined, for example, by means of an absorption spectrum.

When carrying out the process of the invention, it is thus necessary to match active metal precursor, support and activating radiation in order to be able to achieve liberation of the active metal.

The active metal precursor is then applied to the porous support. The active metal precursor is applied both to the exterior surface and the internal surface of the porous support. In the process of the invention, use is made of a porous support which has a very high specific surface area and in which the predominant proportion of the surface area is provided within the pores of the support. The term “applied” also includes the procedure by means of which the active metal precursor is introduced into the pores in the interior of the support. It is in principle possible to use any methods for applying the active metal precursor. The active metal precursor can, for example, be applied as a solution in an inert solvent or else without solvent from the gas phase. Inert solvents used are usually nonpolar aliphatic or aromatic hydrocarbons, since the active metal precursors usually likewise have very nonpolar properties. When the porous support is loaded with an active metal precursor dissolved in an inert solvent, it is possible to achieve loadings in the range of preferably 1-4% by weight of active metal. In the case of loading from the gas phase, significantly higher loadings can be achieved. Loadings of more than 10% by weight, preferably more than 20% by weight, in particular more than 30% by weight, of active metal are achieved, based on the porous support. Upper limits to the loading of the porous support are usually up to 40% by weight, preferably up to 50% by weight. The active metal precursor is preferably applied from the gas phase. Before illumination, the solvent is preferably firstly evaporated, if appropriate under reduced pressure or at elevated temperature.

When the active metal precursor is applied, it generally does not yet react with the porous support but is adsorbed on the surface or in the pores of the porous support by means of comparatively weak interactions. The porous support and the active metal precursor thus form an adduct from which the active metal precursor can largely be diffused off again, for example by heating. If, for example, siliceous compounds such as sheet silicates or zeolites are used as porous supports, bonding of the active metal precursor to the porous support can occur, for example, via hydroxy groups on the support. In the case of other porous supports in which no groups are available for coordinate or ionic interaction, adduct formation can occur on the basis of van der Waals interactions.

The adduct of active metal precursor and porous support is then, if appropriate after removal of traces of solvent, illuminated with the activating radiation. The duration and intensity of illumination is selected as a function of the system of porous support, active metal precursor and activating radiation used. The appropriate parameters can readily be determined by means of appropriate preliminary experiments. Illumination can be carried out under reduced pressure in order to be able to remove, for example, by-products which are liberated from the active metal precursor.

For the purposes of the process of the invention, an active metal is a metal which in the finished catalyst has a catalytic effect on the reaction to be catalyzed. In the case of a catalyst for the synthesis of methanol, this is, for example, copper which in the active form of the catalyst is present predominantly as metal. Correspondingly, an active metal precursor is a compound from which the active metal can be liberated. In the process of the invention, compounds which comprise at least one atom of the active metal and at least one group which is bound via a ligator atom to the active metal atom are used as active metal precursors. The ligator atom is selected from among oxygen, sulfur, nitrogen, phosphorus and carbon. The active metal preferably bears organic groups, i.e. groups which in addition to the ligator atoms O, S, N, C and P have at least one carbon atom. These organic groups preferably have from 1 to 24 carbon atoms, in particular from 1 to 6 carbon atoms. The groups bound to the active metal are preferably selected so that they absorb the activating radiation.

Apart from the ligator atom, further heteroatoms or heteroatomic groups which act as Lewis bases to coordinate to the active metal and thereby stabilize the active metal precursor can be bound to the carbon skeleton. Suitable organic groups are, for example, alkoxides or amino-functionalized alkoxides. The active metal precursors are selected so that they can penetrate into the pores of the porous support. The diameter of the active metal precursor in at least two dimensions is preferably not more than 90% of the pore diameter of the porous support, particularly preferably not more than 80% and very particularly preferably not more than 50% of the pore diameter. Particular preference is given to the diameter of the active metal precursor in all three spatial dimensions being not more than 90%, in particular not more than 80%, preferably not more than 50%, of the pore diameter of the porous support. However, thermal excitation enables larger active metal precursors whose diameter can even be greater than the pore diameter to be introduced into the porous support. However, since the process is preferably carried out at low temperatures, preferably in the region of room temperature, the active metal precursors preferably have a diameter which is smaller than the pore diameter of the porous support.

The active metal precursor preferably has at least two groups which are bound via a ligator atom selected from among oxygen sulfur, nitrogen, phosphorus and carbon to the active metal atom. The groups in the active metal precursor are particularly preferably bound via carbon as ligator atom to the active metal.

For the purposes of the present invention, a “porous support” is preferably a support which has voids which are open on at least one side. The opening of these voids preferably has a diameter of from about 0.5 to 20 nm, preferably from about 0.7 to 10 nm, particularly preferably from about 0.7 to 5 nm and very particularly preferably from about 0.7 to 2 nm, at least along one dimension. The term “void” is to be interpreted broadly. Such a void can, for example, be an approximately spherical void or a channel having a defined geometry, as is realized, for example, in zeolite materials. However, the void can also be formed between two layers, for example in sheet silicates. However, the void has a comparatively small opening so that the active metal precursor can diffuse in a controlled fashion into the void and be deposited there. In the case of sheet silicates, the abovementioned diameter of from about 0.7 to about 20 nm therefore corresponds essentially to the sheet spacing. In the case of spherical voids, the porous support has pores having an approximately circular outline.

The dimensions of the opening of the void can, for example, be determined by nitrogen adsorption measurements using the BJH method (DIN 66134). In the case of highly crystalline compounds, for example the MOFs described below (MOF=metal organic framework), the pore size can, for example, be calculated from X-ray structure data in conjunction with the appropriate simulation programs.

The porous support has a high specific surface area of at least 500 m²/g, preferably at least 600 m²/g, more preferably above 800 m²/g, particularly preferably above 1000 m²/g. The specific surface area is determined by nitrogen adsorption measurements according to the BET method (DIN 66131). When MOFs are used, the specific surface area can be determined by the Langmuir method (DIN 66135).

The porous supports preferably have a pore volume of more than 0.09 cm³/g, particularly preferably more than 0.15 cm³/g. If zeolites are used as supports, the pore volume is preferably less than 1.5 cm³/g.

Apart from the active metal precursor, at least one promoter metal can also be present in the adduct of porous support and active metal precursor. For the purposes of the present invention, a promoter metal is a metal which forms the promoter in the finished catalyst. The promoter is generally present in the form of an oxide in the catalyst. In the case of a catalyst for the synthesis of methanol, zinc and, if appropriate, aluminum can form the promoter metals. Further suitable promoter metals are, for example, tin, indium and titanium.

In the adduct, the promoter metal is preferably not present in the form of the metal but in oxidized form, for example as oxide or metal complex. However, these promoters can also be present in the form of metals in the finished catalyst. Such promoter metals make it possible, for example, to poison noble metal particles, i.e. the active metals, deliberately by alloy formation so as, for example, to increase the selectivity of the catalyzed reaction. The promoter metal can be present in the porous support or can also be introduced as independent compound into the adduct. The promoter metal or a suitable compound of the promoter metal can be introduced into the adduct, i.e. be applied to the porous support, before liberation of the active metal. However, it is also possible firstly to apply the active metal precursor to the porous support and liberate the active metal and then apply the promoter metal, generally in the form of a suitable precursor, to the porous support. In one embodiment of the process of the invention, the promoter metal is likewise applied in the form of a precursor, preferably in the form of a metal organic compound, to the porous support and the promoter metal or a suitable compound of the promoter metal, e.g. an oxide, is liberated from the precursor. Liberation can, for example, be effected by illumination with activating radiation as in the case of the active metal precursor. The promoter metal or the promoter metal compound is preferably deposited like the active metal in nanodisperse form on the porous support.

The precursor of the promoter metal therefore preferably comprises at least one promoter metal and at least one group which is bound via a ligator atom to the promoter metal. Bonding can occur either via a σ bond or via a π bond. The ligator atom can, as in the case of active metal precursor, be selected from among oxygen, sulfur, nitrogen, phosphorus and carbon. The promoter metal preferably bears organic groups, i.e. groups which have at least one carbon atom in addition to the ligator atoms O, S, N, C and P. These organic groups preferably have from 1 to 24 carbon atoms, in particular from 1 to 6 carbon atoms. The promoter metal particularly preferably bears small ligands such as trialkylphosphines in which the alkyl groups preferably each have from 1 to 6 carbon atoms, and also isonitriles, nitrites, cyclopentadienyl groups, alkenyl groups or alkyl groups, preferably methyl groups.

The groups bound to the promoter metal preferably have from 1 to 24, particularly preferably from 1 to 6, carbon atoms and may, if appropriate, also contain groups which are bound via a heteroatom and can act as Lewis bases to stabilize the precursor of the promoter metal. The groups in the precursor of the promoter metal are preferably selected from among alkyl groups, alkenyl groups, aryl groups, a cyclopentadienyl radical and its derivatives and also a hydride group.

In the process of the invention, particular metal organic compounds are thus advantageous as active metal precursors or as precursor for the at least one promoter metal.

For the present purposes, metal organic compounds are:

1. metal complexes in which there are direct metal-carbon bonds;
2. metal complexes in which there is no metal-carbon bond but (coordinated) ligands which are organic in nature, i.e. belong to the family of hydrocarbon compounds or derivatives thereof, are present.

“Metal organic” thus distinguishes from purely inorganic metal complexes which contain neither metal-carbon bonds nor organic ligands.

The order in which the at least one active metal precursor and, if appropriate, the precursor of the at least one promoter metal are applied to the porous support is in principle not subject to any restrictions. The support can firstly be laden with the active metal precursor and the precursor of the promoter metal can then be applied before the active metal and, if appropriate, the promoter metal are deposited on the support by illumination with the activating radiation. However, it is also possible firstly to apply the precursor of the promoter metal to the support and subsequently apply the active metal precursor and then fix these on the porous support by illumination with the activating radiation. It is also possible firstly to apply the active metal precursor to the porous support and fix the active metal by irradiation with the activating radiation. The promoter metal precursor can then be applied to the porous support which has previously been coated with the active metal and be fixed there. Fixing of the promoter metal or the promoter metal compound, e.g an oxide of the promoter metal, can be effected by illumination with the activating radiation or by other methods, e.g. by oxidation or reduction with a suitable gaseous oxidizing agent or reducing agent. It is also possible to apply the active metal precursor and the precursor of the promoter metal alternately a number of times to the support. The active metal precursor and the precursor of the promoter metal are here firstly physisorbed or chemisorbed on the surfaces of the porous support, in particular on the surfaces of the voids. The active metal is then liberated from the active metal precursor and deposited and the promoter metal or a suitable compound of the promoter metal is liberated from the promoter metal precursor and deposited by illumination with the activating radiation.

The individual metal or metal oxide components of the catalyst are particularly preferably applied to the porous support from the gas phase. In this case, the active metal precursors and, if promoter metals are to be introduced into the adduct or the catalyst, the promoter metal precursors of the metals preferably have a vapor pressure of at least 0.1 mbar at 298 K. In a particularly preferred embodiment of the process of the invention, metal organic complexes are thus used as active metal precursors and, if intended in the catalyst, as precursors of the promoter metals. In the case of loading from the gas phase, loadings with the active metal or the promoter metal of up to 40%, preferably up to 50%, based on the weight of the porous support, can advantageously be achieved.

Combinations of these processes are also possible. For example, the active metal precursor can be applied in solution and the precursor of the promoter metal can subsequently be applied from the gas phase. It is likewise possible firstly to apply the active metal precursor from the gas phase and subsequently apply the precursor of the promoter metal in solution. This is followed by fixing of at least the active metal by irradiation with the activating radiation.

If the active metal precursor and, if appropriate, the precursor of the promoter metal are applied to the porous support from the gas phase, the stoichiometry of the catalyst produced can be controlled very precisely. The deposition can be set very precisely by means of the pressure selected or the temperature selected.

In the process of the invention, the active metal is liberated from the active metal precursor by illumination with an activating radiation. The activating radiation used, i.e. its wavelength, depends on the active metal precursor and on the material of the porous support. It is appropriate to use an activating radiation which provides a sufficient energy density, for example microwave radiation. However, it is also possible to use ultrasound as activating radiation. However, ultraviolet radiation is preferably chosen as activating radiation. For example, the spectrum of a mercury vapor lamp, in particular radiation having a wavelength of 254 nm, is suitable. The activating radiation is particularly preferably selected in a wavelength range from 10⁻⁶ to 10⁻⁸ m, preferably from 10⁻⁶ to 10⁻⁷ m.

The process of the invention is carried out using specific support materials on which the active metal and, if appropriate, the promoter are deposited. The support materials have a high porosity which can be set in the nanometer range and thus an extremely high specific surface area. The inventors assume the model concept that the voids or pores act as dimensionally restricted reaction spaces so that undesirable particle growth does not occur in production of the catalyst. The void has a comparatively small opening, so that the active metal precursor can diffuse in a controlled fashion into the void and be deposited there. Only a limited amount of the active metal therefore deposits in each void. After liberation, the active metal is therefore distributed in nanodisperse form on the walls of these reaction spaces or in the reaction spaces themselves. The maximum diameter of the particles does not exceed the pore diameter, which is, for example, about 2 nm when using an MCM-41, in at least one direction. In further process steps in which the catalyst is, for example, heated to elevated temperatures, no exchange between the various voids takes place, so that growth of the catalytically active particles is largely suppressed and the nanodisperse distribution of the catalytically active sites is largely maintained. In addition, this favorably influences the long-term stability of the catalysts under process conditions. Since the surface of the porous support materials is formed essentially by the pores of the support material, the active metal precursors and, if appropriate, the precursors of the promoter metals absorb preferentially on the internal surface of the support materials and thus come into each others immediate chemical vicinity in a very controlled fashion. This has a positive effect both on the dispersion of the active metal particles and on the promoter components. As a result, the close surface contact or interfacial contact of support, active metal particles and promoter components required for the catalytic properties is ensured in a novel way.

In a particularly preferred embodiment, MOFs (metal organic frameworks) are used as porous supports. These systems comprise metal atoms which are three-dimensionally linked via at least bidentate organic ligands to form a network and are suitable, for example, for the storage of hydrogen. These compounds have very high pore volumes of about 2-3 cm³/g and up to 10 cm³/g and also very high specific surface areas of more than 1000 m²/g, particularly preferably more than 2000 m²/g. MOFs form crystal-like structures which form large voids. The inventors assume that the active metal and, if appropriate, the promoter metal or a suitable promoter metal compound form assemblies of a few metal atoms which are incorporated in the network-like structure of the MOF. The size of such an assembly of metal atoms is then limited by the size of the individual void. If the MOF consists of, for example, a three-dimensional assembly of cube-shaped voids, spherical assemblies of metal atoms and, if appropriate, other compounds can be incorporated into these voids.

In a preferred embodiment of the process of the invention, the MOF is formed by a zinc carboxylate. These crystalline substances have extremely high specific surface areas of up to 4500 m²/g and pore volumes of up to 0.69 cm³/cm³ combined with a high thermal stability of up to 350° C. for, for example, MOF-177.

The zinc carboxylate is particularly preferably formed by MOF-5. MOF-5 is formed by zinc atoms which are three-dimensionally crosslinked by terephthalic acid. MOF-5 is discussed, for example, in H. Li, M. Eddaoudi, M. O'Keeffe, O. M. Lughi, Nature (402) 1999, 276-279. If copper is introduced as active metal into the zinc carboxylate, the zinc present in the zinc carboxylate can act as promoter metal.

The process of the invention makes it possible to apply a plurality of different active metals in nanodisperse form to the porous support or incorporate them into its structure in a controlled manner.

If the catalytically active metal component comprises a plurality of metals or metal compounds, for example metal oxides, these are in intimate contact since the individual constituents are each present in nanodisperse form. The particular characteristic of the process of the invention is that, in contrast to other known impregnation processes, the active metal is deposited and chemically fixed in a reaction space limited to nanosize dimensions by the support as a result of the illumination of the active metal precursors with an activating radiation.

In the air-stable storage form of the catalyst, the active metals are usually present in the form of an oxide. Exceptions are very noble active metals such as Pt and Pd, etc. The oxides are formed as a result of atmospheric oxidation after production of the catalyst. However, it is possible in an established way according to the prior art to oxidize the metal form only partly by means of specific stabilization measures. In such a case, the active metal is passivated by a thin oxide layer. After introduction into the reactor, the catalyst can be converted back into its active form by means of a mild and simple rereduction. For this purpose, the oxide layers are, for example, reduced by means of hydrogen.

In particular, with a view to catalyst regeneration, the quality of the catalytic activity of the system and its chemical composition and structural characteristics are not changed significantly by repeated oxidation and reduction cycles; i.e. an appropriate catalyst regeneration for restoring the original catalytic activity is possible in an advantageous way.

The active metal is preferably selected from the group consisting of Al, Zn, Sn, Bi, Cr, Ti, Zr, Hf, V, Mo, W, Re, Cu, Ag, Au, Ni, Pd, Pt, Co, Rh, Ir, Fe, Ru and Os.

The active metal can comprise only one metal from the abovementioned group, for example copper or zinc. However, it is also possible for the active metal to comprise a plurality of metals from the abovementioned group, for example two or three metals. The metals can be present in reduced form as pure metal or as metal compound, in particular as metal oxide, on the porours support. As mentioned above, the active metal is usually present in at least partly oxidized form in the transport form of the catalyst, so that the catalyst is also sufficiently stable in air.

In a preferred embodiment, the promoter metal is selected from the group consisting of Al, Zn, Sn, rare earth metals and alkali metals and alkaline earth metals. Suitable alkali metals and alkaline earth metals are, for example, Li, Na, K, Cs, Mg and Ba. The active metal and the promoter metal are selected so as to be different for the catalyst.

If a catalyst for the synthesis of methanol or a reformer for fuel cell technology is produced by the process of the invention, the catalyst preferably comprises the system Cu/Zn/Al. Here, the atomic ratios of Cu/Zn/Al are typically in the range from 1:3:0.1 to 3:1:1. The copper can be introduced by means of a suitable active metal precursor, the zinc via, for example, a suitable promoter metal precursor or via the material of the porous support and the aluminum likewise via the material of the porous support or via a suitable promoter metal precursor.

The active metal precursor is preferably a compound of the formula MeXₚLₒ, where Me is an active metal, X is selected from the group consisting of straight-chain and branched alkyl groups having from 1 to 6 carbon atoms, cycloalkyl groups having from 3 to 8 carbon atoms, alkenyl groups having from 2 to 6 carbon atoms, e.g. an allyl group, aryl groups which have from 6 to 18 carbon atoms and may in turn be substituted by alkyl groups having from 1 to 6 carbon atoms, halogen atoms or amino groups, cyclopentadienyl groups which may be unsubstituted or substituted by one or more alkyl groups having from 1 to 6 carbon atoms, phosphanes, in particular alkylphosphanes having from 1 to 9 carbon atoms; silanes, cyanates and isocyanates having from 1 to 6 carbon atoms, alkoxides (OR*), amides (NR₂*), β-diketonates (R*(═O)CHC(═O)R*) and their nitrogen analogues, in particular β-ketoiminates (R*(═O)CHC(═NR*)R*) and β-diiminates (R*(═NR*)CHC(═NR*)R*), carboxylates (R*COO), oxalates (C₂O₄), nitrates (NO₃) and carbonates (CO₃), where R* is an alkyl radical having from 1 to 6 carbon atoms, an alkenyl radical having from 2 to 6 carbon atoms, an aryl radical having from 6 to 18 carbon atoms, and the radicals R* may be identical or different, p is an integer corresponding to the valence of the active metal, o is an integer from 0 to the number of free coordination sites of the active metal atom and L is a Lewis-basic organic ligand which comprises oxygen, nitrogen, phosphorus or carbon as ligator atom. L and X can comprise only one type of the ligands or radicals mentioned. However, it is also possible to provide combinations of the groups mentioned.

In an embodiment of the process of the invention, the promoter metal precursor is a compound of the formula MRⁿLₘ, where M is a promoter metal, R can have one of the meanings of the group “X” in the active metal precursor, n is an integer corresponding to the valence of the promoter metal, L is a Lewis-basic organic ligand comprising oxygen, nitrogen, phosphorus or carbon as ligator atom and m is an integer from 0 to the number of free coordination sites of the promoter metal atom. In the case of the precursor for the promoter metal, too, it is possible to use only one type of the groups mentioned for the radical R and the ligand L. However, it is likewise possible to combine various groups.

As ligands L, it is possible to use, for example, compounds of the formula OR′R″, NR′R″R′″, PR′R″R′″ or CR′R″R′″, where the radicals R′, R″ and R′″ are each hydrogen or an alkyl group having from 1 to 6 carbon atoms, with two of these radicals together with the heteroatom also being able to form a ring.

Particular preference is given to precursors of the promoter metals in which the formula MRₙLₘ is selected from among ZnR₂Lₘ and AlR₃Lₘ, where m=0, 1 or 2 and R and L are as defined above.

The porous support can consist of any material as long as the material has the required transparency to the activating radiation. However, the support should have the above-described voids which have a relatively small opening having the dimensions indicated above. Thus, for example, the abovementioned MOFs are suitable as porous support materials.

If the catalysts are used at elevated temperature, the support is preferably made up of an inorganic material. Examples of suitable inorganic materials are zeolites, PMS, sheet silicates such as bentonites, clays or pillard clays, hydrotalcites and heteropolyacids, e.g. of molybdenum and tungsten.

In a preferred embodiment, periodic mesoporous silicate materials (PMSs) are used since these have very high specific surface areas and allow the pore structure to be set precisely. Examples are MCM-41, MCM-48 and SBA-15.

Among the zeolites, preference is once again given to those which have a large pore radius. Zeolites having a pore radius of ≧0.7 nm are, for example, mordenite, VPI-5 or cloverites.

In a particularly preferred embodiment, MOFs are used as porous support materials. The MOFs are formed by a metal component which is three dimensionally linked by an at least bidentate ligand so as to give a crystal-like structure having periodically repeating structural units. Possible metals or metal ions are the elements of groups Ia, IIa, IIa, IV-VIIIa and Ib-VIb of the Periodic Table of the Elements. As at least bidentate ligands, it is possible to use, for example, substituted and unsubstituted aromatic dicarboxylic acids having one or more rings and substituted or unsubstituted aromatic dicarboxylic acids having one or more rings and at least one heteroatom. Specific examples which may be mentioned are dicarboxylic acids of benzene, naphthalene, pyridine or quinolines. The metal component is particularly preferably selected from among metals of the group consisting of Zn, Cu, Fe, Al, Sn, In, Ti which are three-dimensionally crosslinked by at least bidentate ligands Z-R^{a}-Z. Z is a carboxy group, a carbamide group, an amino group, a hydroxy group, a thiol group or a pyridyl group. R^{a} is a phenylene group which may be substituted by alkyl groups having 1-6 carbon atoms, alkenyl groups having 2-6 carbon atoms, alkoxy groups having 1-6 carbon atoms and from 1 to 3 oxygen atoms, halogen atoms or amino groups. R^{a} can also have a plurality of benzene rings and be selected, for example, from the group consisting of

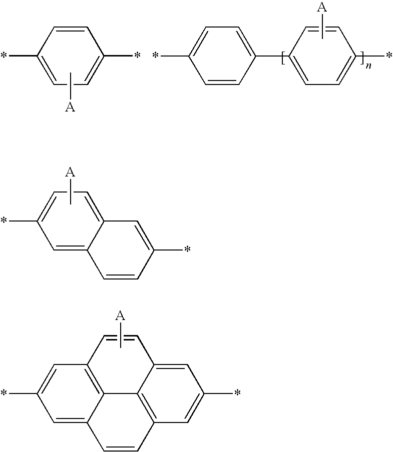

where A represents hydrogen, alkyl groups having 1-6 carbon atoms, alkenyl groups having 2-6 carbon atoms, alkoxy groups having 1-6 carbon atoms and from 1 to 3 oxygen atoms, halogen atoms or amino groups, and A can be identical or different on each occurrence. It is also possible for a plurality of substituents A to be present on the aromatic skeleton, i.e. the groups shown above can also bear a plurality of substituents A, for example 2, 3 or 4.

Particular preference is given to R being a phenylene group, X being a carboxy group and A being hydrogen.

The production of the catalyst is carried out under extremely mild conditions. Thus, a temperature of 200° C. is preferably not exceeded during production of the catalyst. The production is particularly preferably carried out at room temperature and under reduced pressure. The active metal is thereby deposited in finely divided form, with the diameter of the particles produced from the active metal generally being in the range from about 0.5 to 10 nm, preferably from 0.5 to 5 nm. Any promoter present can also be deposited in finely divided form, so that a very large contact area between active metal and promoter can be achieved. This leads to catalysts having a very high activity.

The invention therefore also provides a catalyst comprising a porous support having a specific surface area of at least 500 m²/g and at least one active metal or an active metal oxide, wherein the porous support is formed by an MOF.

The special feature of the catalyst of the invention is that it comprises an MOF as porous support. This MOF comprises metal atoms which are three-dimensionally linked via bidentate ligands to form a network. The network contains large voids which can be filled with the active metal. Very high loadings are achieved here, up to more than 40% by weight based on the MOF. The individual voids in the MOF form cells between which only limited exchange of metal atoms is possible. The active metal is enclosed in the MOF in the form of small particles whose size is limited by the size of the void and which therefore display essentially no particle growth and provide a very high surface area of the active metal. As a result, the catalysts display a very high activity and a very high stability even over long periods of operation. The inventors assume that because of the network-like structure of the MOF the active metal and, if appropriate, further components such as promoter metals are not deposited on the structure of the MOFs as on the walls of the pores of a zeolite but are enclosed as discrete particles in the network. The metal present in the MOF can interact with the active metal. However, this interaction is usually only very weak or entirely absent.

As indicated above, the MOF is made up of metal atoms which are arranged on lattice positions. Between these metal atoms, there are at least bidentate ligands which connect the metal atoms. In a simple case, the metal atoms are arranged at the corners of a cube while the bidentate ligands are arranged along the edges of the cube. The size of the cube and thus the void enclosed within can be tailored by means of the dimensions or the length of the bidentate ligand.

As indicated further above, the metal component of the MOF is selected from among elements of groups Ia, IIa, IIIa, IV-VIIIa and Ib-VIb. The metals of the MOF are preferably selected from the group consisting of Zn, Cu, Fe, Al, Sn, In, Ti.

Examples of suitable bidentate ligands have been mentioned above. The at least bidentate ligand of the MOF is preferably selected from among compounds of the formula

Z-R^{a}-Z

where Z is a carboxy group, a carbamide group, an amino group, a hydroxy group, a thiol group or a pyridyl group and R^{a} is selected from among

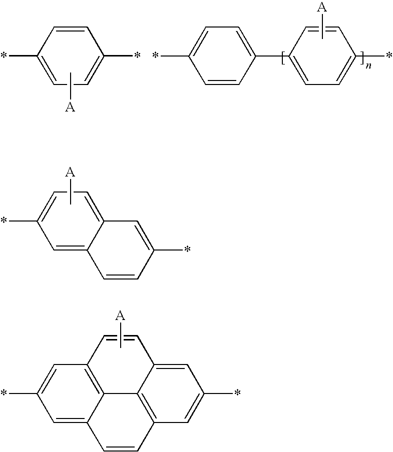

where A represents hydrogen, alkyl groups having 1-6 carbon atoms, alkenyl groups having 2-6 carbon atoms, alkoxy groups having 1-6 carbon atoms and from 1 to 3 oxygen atoms, halogen atoms or amino groups, with A being able to be identical or different on each occurrence and a plurality of groups A also being able to be provided, for example 2, 3 or 4.

Due to its network-like structure, the MOF allows very high degrees of loading. The degree of loading of the MOF with the active metal is preferably at least 20% by weight, more preferably at least 30% by weight, particularly preferably at least 40% by weight, based on the weight of the MOF.

The active metal is selected as a function of the reaction to be catalyzed. Suitable active metals have been mentioned above.

In addition to the active metal, the catalyst of the invention can further comprise at least one promoter metal or a promoter metal compound. The promoter metal can either be a constituent of the MOF or is preferably incorporated like the active metal in the voids of the MOF. As promoter metal compound, the catalyst of the invention preferably contains an oxide of the promoter metal. Suitable promoter metals have been mentioned above.

The catalyst of the invention makes a very large surface area of the active metal available. The active metal present in the catalyst preferably has a specific metallic surface area of at least 5 m²/g_{active metal}, preferably at least 10 m²/g_{active metal}, particularly preferably at least 25 m²/g_{active metal}. If the catalyst also comprises a promoter which is, in particular, incorporated in the voids of the MOF, the promoter preferably has a specific surface area of at least 25 m²/gₚᵣₒₘₒₜₑᵣ, preferably at least 100 m²/gₚᵣₒₘₒₜₑᵣ, particularly preferably at least 500 m²/gₚᵣₒₘₒₜₑᵣ. The specific surface area of the active metal can be determined by gas adsorption/desorption methods. Such a method is, for example, N₂O reactive frontal chromatography for determining the specific surface area of copper. Analogous methods can be employed for other active metals. They are generally based on occupation of the metal surface by a molecule having a known space requirement, with the amount of adsorbed molecules being determined. The specific surface area of the promoter can be estimated by determining the degree of aggregation by means of X-ray absorption studies and by BET surface area determination on the laden support. The content of promoter component can be determined by elemental analysis (e.g. atomic absorption spectroscopy or energy-dispersive X-ray absorption spectroscopy).

An important feature of the catalyst of the invention is the extremely small size of the active metal particles which are incorporated in the network in the form of nanoparticles. The size of the particles can be determined, for example, by transmission electron microscopy. Small spheres of the active metal which have a diameter of preferably less than 5 nm, more preferably less than 2 nm and particularly preferably about 1 nm, can be seen on the transmission electron micrographs. The active metal particles in the MOF particularly preferably have a diameter in the range from about 0.5 to 4 nm.

The catalyst which can be obtained by the process of the invention brings a number of advantages, as will be illustrated below in an example of an embodiment of the catalyst of the invention as catalyst for the synthesis of methanol.

The catalyst of the invention differs from the known Co/Zn/Al catalysts for the synthesis of methanol in the following criteria:

(1) the dispersion of the Cu component (or the active metal) is very high, at least 25 m²_{cu}x g⁻¹_{cu}, i.e. at the same proportion by mass of catalytically active Co component, the catalyst of the invention is more active or, for the same specific activity, namely activity based on the active metal surface area, a smaller proportion by mass of copper (active metal) is sufficient compared to known catalysts. The analytical characterization of the catalyst by means of EXAFS (extended X-ray absorption fine structure spectroscopy) and XRD (X-ray diffraction) shows that the majority of the Cu particles have dimensions of from about 1 to 3 nm, which typically indicates aggregates of 10-20 Cu atoms.
(2) in contrast to known Cu/ZnO/Al₂O₃ catalysts, the support is formed by an MOF which has defined voids. The size of the active metal particles can be set in a targeted manner via the size of the voids. The catalytically active metal is therefore not present in the form of a coating on the pore walls but in the form of particles having a defined size which is determined by the size of the void of the MOF.

The catalysts of the invention have a high activity based on the proportion by mass of the catalytically active metal components. They are therefore particularly suitable for use as catalyst for the synthesis of methanol or as reformers in fuel cell technology.

The invention is illustrated below with the aid of examples and with reference to the accompanying figures. The figures show:

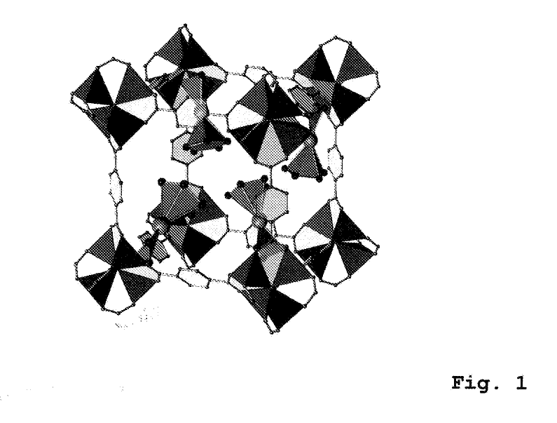

FIG. 1: a depiction of an MOF-5 cage having four incorporated [(η⁵-C₅H₅)Pd(η³-C₃H₅)] precursors, with the unit cell of the crystalline MOF-5 formally containing 8 voids of this type;

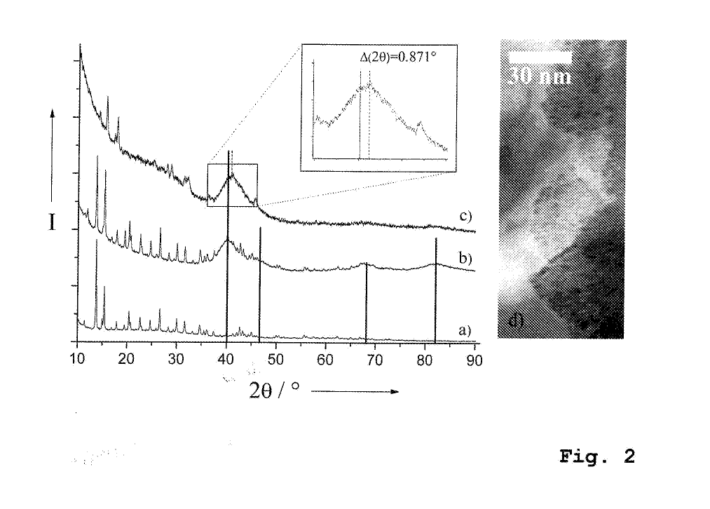

FIG. 2: X-ray powder diffraction pattern of the systems:
a) MOF-5,
b) UV-Pd@MOF-5 (photolytically reduced);
c) Pd@MOF-5 (reduction by means of H₂). 2θ values characteristic of palladium are indicated. The magnification shows the 20 shift to higher angles, which is typical of small particles;
d) transmission electron micrograph of UV-Pd@MOF-5.

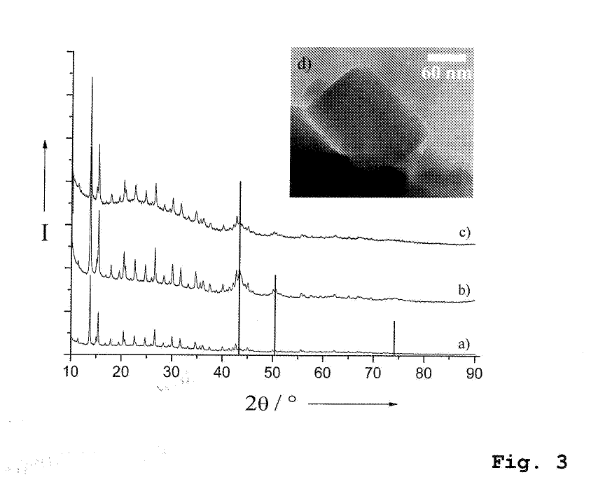

FIG. 3: X-ray powder diffraction patterns of the systems:
a) MOF-5;
b) UV-Cu@MOF-5 (photolytically reduced);
c) Cu@MOF-5 (after methanol catalysis test, reduction by means of H₂);
d) transmission electron micrograph of Cu@MOF-5 (sample b);

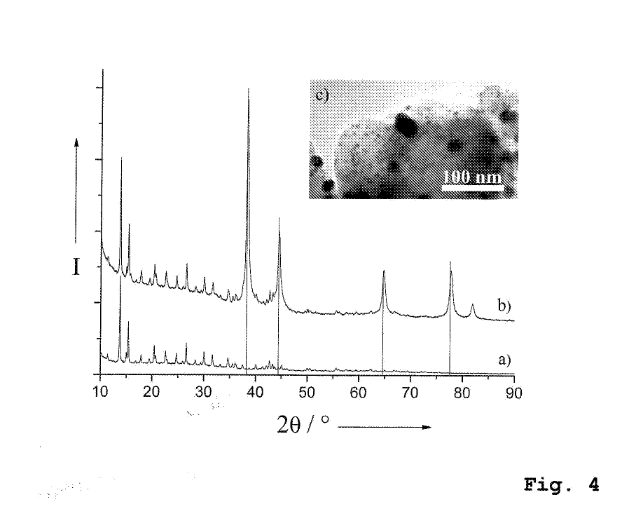

FIG. 4: X-ray powder diffraction patterns of the systems
a) MOF-5;
b) Au@MOF-5 (after reductive treatment with hydrogen at 190° C.);
c) transmission electron micrograph of Au@MOF-5.

### EXAMPLES

### Characterization of the Samples

The following routine methods were used: IR spectra were recorded as KBr pellets on a Perkin Elmer FT-IR 1720 X spectrometer, NMR spectra were recorded on a Bruker DSX, 400 MHz spectrometer under MAS conditions in ZrO₂ rotors. An AAS apparatus model 6 (1998) from Vario was used for metal determination; C,H,N analyses were carried out using the CHNSO EL (1998) instrument from the same manufacturer. The X-ray powder diffraction patterns (PXRD) of the samples [precursor] n@MOF-5 or metal@MOF-5 were recorded by means of a D8-Advance Bruker AXS diffractometer using Cu Kα radiation (λ=1.5418 Å) in Θ-2Θ geometry and using a position-sensitive detector. For this purpose, the samples were introduced into capillaries under protective gas and these were then flame sealed. To determine the position of the reflections and the width at half height of the Pd(111), Cu(111) and Au(111) reflections, all diffraction patterns were fitted by means of the Topas P 1.0 software using a pseudo-Voigt function.

Transmission electron microscopic studies (TEM) were carried out on a Hitachi H-8100 instrument at 200 kV using a tungsten filament. All metal@MOF-5 samples were prepared with exclusion of air and also transferred with strict exclusion of air (Gold-Grids Ted Pella, vacuum transfer container). Nitrogen adsorption measurements were carried out using a Quantachrome Autosorb-1 MP apparatus. The specific surface area (SLangmuir) Of the empty MOF-5 and the metal@MOF-5 samples was determined by fitting to the Langmuir surface area model in the pressure range p/p0=0.1-0.3 at a temperature of 77.36 K. Evaluation was carried out in accordance with DIN 66135 using software written inhouse. The copper surface area of Cu@MOF-5 was determined by the method described by O. Hinrichsen, T. Genger, M. Muhier, Chem. Eng. Technol. 23 (2000) 11, 956-959. The methanol synthesis activity was determined as described by M. Kurtz, N. Bauer, C. Büscher, H. Wilmer, O. Hinrichsen, R. Becker, S. Rabe, K. Merz, M. Driess, R. A. Fischer, M. Muhler, Catalysis Letters Vol. 92, Nos. 1-2, January 2004, 49-52. A mixture of 72% of H₂, 10% of CO, 14% of CO₂ and 14% of He was used as synthesis gas. For the tests on Au-catalyzed CO oxidation, see [J. Assmann, V. Narkhede, L. Khodeir, E. Löffler, O. Hinrichsen, A. Birkner, H. Over, M. Muhler, J. Phys. Chem. B 2004, 108(38), 14634-14642]. For the determination of the Pd surface area and details of the COE hydrogenation, see ref. [J. E. Benson, H. S. Wang and M. Boudart, J. Catal. 1973, 30, 146-153].

### Example 1

### Metal@MOF-5

The preparation of the metal@MOF-5 compounds was carried out using the following compounds:

| Compound number | Structure |
|---|---|
| 1 | [(η⁵ − C₅H₅)Pd(η³ − C₃H₅] ^{[1]} |
| 2 | [(η⁵ − C₅H₅)CuPMe₃] ^{[2]} |
| 3 | [(CH₃)AuPMe₃] ^{[3]} |

^{[1]} a) Y. Zhang, Z. Yuan, R. J. Puddephatt, Chem. Mater. 1998, 10(8), 2293-2300. b) J. E. Gozum, D. M. Pollina, J. A. Jensen, G. S. Girolami, J. Am. Chem. Soc. 1988, 110, 2688-2689, d) R. R. Thomas, J. M. Park, J. Electrochem. Soc. 1989, 136, 1661-1666.
^{[2]} a) H. Werner, H. Otto, Tri Ngo-Khac, Ch. Burschka, J. Organomet. Chem. 1984, 262, 123-136; b) M. J. Hampden-Smith, T. T. Kodas, M. Paffett, J. D. Farr, H. -K. Shin, Chem. Mater. 1990, 2, 636-639; c) D. B. Beach, F. K. LeGoues, Ch. -K. Hu, Chem. Mater. 1990, 2, 216-219.
^{[3]} a) H. Schmidbaur, A. Shiotani, Chem. Ber. 1971, 104, 2821-2830; b) J. L. Davidson, P. John, P. G. Roberts, M. G. Jubber, J. I. B. Wilson, Chem. Materials 1994, 6, 1712-1718; c) H. Uchida, N. Saito, M. Sato, M. Take, K. Ogi, Jpn. Kokai Tokkyo Koho 1995, 6 pp.

a) Thermal MOCVD loading:

Freshly synthesized [H. Li, M. Eddaoudi, M. O'Keeffe, O. M. Yaghi, Nature 1999, 402, 276-279, a) A. Stein, Adv. Mater. 2003, 15(10), 763-775; b) N. L. Rosi, J. Eckert, M. Eddaoudi, D. T. Vodak, J. Kim, M. O'Keeffe, 0. M. Yaghi, Science 2003, 300, 1127-1129; c) U. Müller, L. Lobree, M. Hesse, 0. M. Yaghi, M. Eddaoudi, BASF Aktengesellschaft, The Regents of the University of Michigan, U.S. Pat. No. 6,624,318 and US2004081611], pure MOF-5 which has been freed of solvent and templates (“empty MOF-5”) (50 mg) is placed together with a portion of 100.0 mg of precursor (1-3) in separate glass boats in a Schlenk tube and heated in a static vacuum (1 Pa) for 3 hours at 343 K (for 2 and 3) or left at room temperature (for 1). The defined intermediates [precursor] n@MOF-5 obtained in this way are analytically characterized as described above. Samples of 40 mg are then reduced under H₂ at 23° C. (30 minutes) in the case of Pd@MOF-5 or at 150° C. (60 minutes) in the case of Cu@MOF-5 and 190° C. (120 minutes) in the case of Au@MOF-5. Cooling to room temperature under reduced pressure (10⁻³ mbar) (120 minutes) removes traces of the gaseous decomposition products (monitoring by means of IR and 13C-/31P-MAS-NMR).

### b) Photolytic MOCVD Loading

Samples of 30 mg of the intermediates [precursor] n@MOF-5 prepared as described above are photolyzed (Hg high-pressure lamp, 500 W, Normag TQ 718) at 30° C. for 120 minutes in a stream of inert gas (Ar, He) and traces of remaining ligand fragments are removed under reduced pressure as described above.

The analytical data for the intermediates [precursor] n@MOF-5 and the metal@MOF-5 samples are summarized in Table 1 and the catalysis data are summarized in Table 2.

TABLE 1
Loading density of various precursors in MOF-5

| | | Elemental analysis | | | Volume of precursor^{[a]} | | |
|---|---|---|---|---|---|---|---|
| | | measured/calculated | | | per | per unit | Occupation |
| | Molecules | M | C | H | molecule | cell of MOF-5 | of the pore |
| Precursor | per void | [%] | [%] | [%] | [Å³] | [Å³] | volume^{[c]} |
| CpPd(allyl) | 4 | 26.4/26.3 | 41.5/41.5 | 3.14/3.2 | 196.6 | 6291^{[b]} | 45.3% |
| MeAuPMe₃ | 4 | 40.8/41.0 | 23.4/24.9 | 3.4/3.1 | 159.3 | 5098^{[b]} | 36.7% |
| CpCuPMe₃ | 2 | 10.7/10.8 | 40.4/40.7 | 3.4/3.4 | 242.6 | 3882^{[b]} | 28.0% |

^{[a]}Calculation using Gaussian 98 (B3LYP/SDD); R. Becker, H. Parala, F. Hipler, A. Birkner, C. Wöll, O. Hinrichsen, O. P. Tkachenko, K. V. Klementiev, W. Grünert, S. Schäfer, H. Wilmer, M. Muhler, R. A. Fischer, Angew. Chem. 2004, 116, 2899-2903; Angew. Chem. Int. Ed. 2004, 43, 2839-2842;
^{[b]}The unit cell of MOF-5 consists of 8 voids
^{[c]}The network of MOF-5 occupies only 20% of the unit cell volume; H. Li, M. Eddaoudi, M. O'Keeffe, O. M. Yaghi, Nature 1999, 402, 276-279; V_{(unit cell)} = 17 343.6 \check{A}³

TABLE 2
Catalytic performance of various metal@MOF-5 systems

| | Productivity | | Metal surface area | % by weight of M | |
|---|---|---|---|---|---|
| Catalyst | [μmol_{MeOH}g⁻¹_{cat}h⁻¹] | [μmol_{MeOH}m⁻²_{Cu}h⁻¹] | [m² _{Cu}g⁻¹_{cat}] | % by weight of Cu | % by weight of Zn |
| Cu@MOF-5 | 70 | 11.1 | 6.33 | 13.8 | 29.0^{[a]} |
| Cu/ZnO@MCM-41 | 19 | 4.1 | 4.6 | 6.9 | 10.4 |
| Cu/ZnO@MCM-48 | 130 | 22.4 | 5.8 | 10.6 | 21.9 |
| | [mmol_{COA}g⁻¹_{cat}h⁻¹] | [μmol_{COA}m⁻²_{cat}h⁻¹] | [m²_{Pd}g⁻¹_{cat}] | % by weight of Pd | |
| Pd@MOF-5 | 47.34 | 1.42 | 33.3 | 35.6 | |
| | [μmol_{CO2}g⁻¹_{cat}h⁻¹] | [μmol_{CO2}m⁻²_{cat}h⁻¹] | [m²_{Au}g⁻¹_{cat}] | % by weight of Au | |
| Au@MOF-5 | — | — | — | 48 | |

^{[a]}Zinc from the MOF skeleton; no additional Zn was introduced into the MOF-5

When 50 mg of pure, freshly synthesized MOF-5 which has been dried gently at 110° C. (removal of embedded solvent) is exposed in a static vacuum (1 Pa) to the vapor of 100 mg of the reddish brown Pd precursor [(η⁵-C₅H₅)Pd(η³-C₃H₅)] at 293 K in a tightly sealed Schlenk tube, the originally colorless to pale beige, microcrystalline MOF-5 becomes deep red within 5 minutes. The Pd adsorption is not completely reversible, but the corresponding loading with pentacarbonyliron is. Quantitative desorption of [Fe(CO)₅] occurs at 0.01 Pa (dynamic vacuum, 298 K, IR monitoring). The three-dimensional crystalline arrangement of the MOF host lattice remains unchanged after loading with [(η⁵-C₅H₅) Pd (η³-C₃H₅)], as comparison of the X-ray powder diffraction patterns before and after adsorption shows. Evaluation of the IR and ¹³C-MAS-NMR solid state spectra together with the elemental analysis data indicates a formal loading per void of precisely 4 intact [(η⁵-C₅H₅)Pd(η³-C₃H₅)] molecules (see FIG. 1, Table 1).

The molecular volume of the precursor can be calculated from the structural data using Gaussian98 (B3LYP/SDD) as 196.6 μl. The Pd precursors [(η⁵-C₅H₅)Pd(η³-C₃H₅)] thus fill 36.3% of the unit cell, which equates to 45.3% of the pore volume. In an analogous way, other metal organic precursors for metal deposition, e.g. [(η⁵-C₅H₅)CuPMe₃] and [(CH₃)AuPMe₃], are also absorbed in unchanged form.

As expected, the size and shape selectivity is very high. In the case of [(η⁵-C₅H₅)CuPMe₃] which occupies less space compared to [(η⁵-C₅H₅)Pd(η³-C₃H₅)] and [(CH₃)AuPMe₃], only two instead of four incorporated molecules are found, although only 28% of the pore volume is then filled with precursor molecules [(η⁵-C₅H₅) CuPMe₃]. The Cu precursor [Cu (OR) 2] (R═CH(CH₃)CH₂NMe₂) which is only slighter larger at 8.3 Å, 10.4 Å and 6.4 Å (principal axes of the circumscribed ellipsoid) and a volume of 327.5 Å³ [R. Becker, A. Devi, J. Weiss, U. Weckenmann, M. Winter, C. Kiener, H. W. Becker, R. A. Fischer, Chem. Vap. Dep. 2003, 9, 149-156] is no longer taken up in MOF-5 at a diameter of the pore openings of 8 Å, but is in contrast taken up by the isoreticular IR-MOF-8 having pore openings widened to about 9.5 Å! Since the partial pressure of the precursors is comparatively low (<1 Pa at 298 K), the question of maximum loading remains open. Loading by solution impregnation has been found to be far less efficient than via the gas phase. The driving force for diffusive exchange of the solvent molecules present in the void with the precursor molecules is low.

When the composite [(η⁵-C₅H₅)Pd(η³-C₃H₅)]₄@MOF-5 is treated with H₂ gas, the reddish powder becomes black in an instant even at −35° C., which indicates reduction to palladium. GC/MS analysis of the fraction of the gases desorbed in the stream of H₂ (293 K, 2 h) which are condensable at 77 K indicates cyclopentane and propane as expected by-products (catalytic hydrogenation of the ligands). In addition, many further species which have been formed as a result of C—C couplings, C—H activations, isomerization and (partial) hydrogenation of the ligands and their C—C coupling products. The resulting Pd@MOF-5 material is thus highly reactive and extremely air sensitive (glowing/burning).

The X-ray diffraction pattern (FIG. 2) of a capillary sample prepared under protective Ar gas displays a very broad reflection (FWHM=5.4°) at 2θ=40.99° which indicates Pd nanocrystallites having dimensions of 1.4 (±0.1) nm (profile analysis using Topas P 1.0, pseudo-Voigt). The shift of the 2θ angle to slightly higher values, which corresponds to a reduction in the Pd—Pd spacings, is likewise characteristic of very small metal particles. The particle size is also confirmed by TEM data (FIG. 2). However, the characteristic reflections for the MOF-5 structure are greatly weakened or completely absent in the diffraction patterns of the Pd@MOF-5 samples prepared by means of H₂ reduction (FIG. 3), while the typical high Langmuir surface areas of about 1600 m²/g are retained. Appreciable hydrogenation of the terephthalate ligands of the framework structure can be ruled out on the basis of the IR data for the material. The inventors assume that only the long-range order of the host lattice is disrupted. A defect or layer structure having 2D order, for example, would be conceivable. The composite Pd@MOF-5 has been found to be a moderately active catalyst for the hydrogenation of cyclooctene (COE), which was chosen as test reaction [X. Mu, U. Bartmann, A. Guraya, G. W. Busser, U. Weckenmann, R. Fischer, M. Muhler, App. Catal. A 2003, 248, 85-95] (Table 2).

Catalytic activity is also found for the material Cu@MOF-5, which has been obtained by reduction of [(η⁵-C₅H₅)Cu(PMe₃)]₂@MOF-5 in a stream of hydrogen at 18° C. (1 h). A methanol production of 70 μmol_{MeOH} g⁻¹_{cat}. h⁻¹ from synthesis gas was achieved (quick test under atmospheric pressure [M. Kurtz, N. Bauer, C. Buscher, H. Wilmer, O. Hinrichsen, R. Becker, S. Rabe, K. Merz, M. Driess, R. A. Fischer, M. Muhler, Catalysis Letters 2004, 92, 49-52]), corresponding to the level of the mesoporous catalysts Cu/ZnO@MCM-41/48 recently described by us (Table 2) [R. Becker, H. Parala, F. Hipler, A. Birkner, C. Wöll, O. Hinrichsen, 0. P. Tkachenko, K. V. Klementiev, W. Grünert, S. Schäfer, H. Wilmer, M. Muhler, R. A. Fischer, Angew. Chem. 2004, 116, 2899-2903; Angew. Chem. Int. Ed. 2004, 43, 2839-2842]. The specific copper surface area of about 6 m²/g (at 13.8% by weight of Cu) was found to be stable under the catalysis conditions. According to the XRD and TEM data (FIG. 3), Cu particles having sizes in the range 3-4 nm and an intact MOF-5 structure are present. The Langmuir surface area was found to be 1100 m²/g (after the catalysis tests!). This activity of Cu@MOF-5 is remarkable since the promotion of Cu by Zn or ZnO, species required for the catalysis is in this case obviously produced in a novel way by the MOF-5 structure which stabilizes the Cu particles and is intact under the catalysis conditions (220° C., CO/H₂).

In the thermal conversion of [(CH₃)Au(PMe₃)]₄@MOF-5 (190° C., 4 h, H₂ stream) into Au@MOF-5, the crystalline host lattice remains completely undisrupted as in the case of Cu@MOF-5 but in contrast to the sample Pd@MOF-5 described further above (XRD and Langmuir). TEM data (FIG. 4) indicate polydisperse Au particles having sizes in the range from 5 to 20 nm. The Au atoms or Au clusters (or nuclei) initially formed by decomposition of [(CH₃)AuPMe₃] are obviously more mobile than the Cu or Pd clusters in the open MOF structure and relatively large aggregates are formed within the pores and diffusion to the outer surface of the MOF crystallites occurs, as indicated by the relatively large Au particles having a size of about 20 nm.

The highly porous Au@MOF-5 material was found to be inactive in respect of the Au-catalyzed oxidation of CO. The Au nanoparticles distributed in the MOF-5 lattice or on the surface of the MOF crystallites obviously lack the strong metal/support interaction or promotion (Au/TiO₂, Au/ZnO) which is necessary for the catalytic effect.

An interesting, alternative and very mild route to metal@MOF materials having an undisrupted, crystalline host lattice is UV photolysis of the intermediates [precursor]ₙ@MOF-5 at room temperature (water cooling) under protective gas (Ar, He) or under reduced pressure. In the case of UV-Pd@MOF-5, GC/MS of the gaseous by-products shows only cyclopentadiene and three further products of the empirical formulae C₈H₁₀ and C₁₀H₁₂. In the case of Cu@MOF-5, C₁₀H₁₂ (fulvalene) and PMe₃ are found. Transmission electron micrographs (FIG. 1) indicate very small Pd and Cu clusters (1-2 nm) below the size regime which can be achieved by thermal methods.

1. A process for producing a catalyst comprising a porous support and at least one active metal, which comprises
providing a porous support which has a specific BET surface area of at least 500 m²/g and is transparent to an activating radiation,
applying at least one active metal precursor, which comprises at least one active metal and at least one group which is bound via a ligator atom selected from the group consisting of oxygen, sulfur, nitrogen, phosphorus and carbon to the active metal, to the porous support so as to produce an adduct, which comprises the porous support and the at least one active metal precursor; and
illuminating the adduct with the activating radiation which is able to induce the release of the active metal from the active metal precursor to convert the at least one active metal into its reduced form.

2. The process as claimed in claim 1, wherein the porous support has a pore volume of more than 0.09 cm³/g.

3. The process as claimed in claim 1, wherein at least one promoter metal or promoter metal compound is present in addition to the active metal precursor in the adduct.

4. The process as claimed in claim 1, wherein the at least one active metal precursor is applied to the porous support by deposition from the gas phase.

5. The process as claimed in claim 1, wherein the activating radiation comprises ultraviolet radiation.

6. The process as claimed in claim 1, wherein the porous support has pores which are open on at least one side, with the opening having a diameter in the range from 0.7 to 20 nm along at least one direction of the opening.

7. The process as claimed in claim 1, wherein the porous support is formed by an MOF.

8. The process as claimed in claim 7, wherein the MOF is formed by a metal and an at least bidentate ligand.

9. The process as claimed in claim 7, wherein the MOF is formed by MOF-5.

10. The process as claimed in claim 1, wherein the active metal precursor contains an active metal selected from the group consisting of Al, Zn, Sn, Bi, Cr, Ti, Zr, Hf, V, Mo, W, Re, Cu, Ag, Au, Ni, Pd, Pt, Co, Rh, Ir, Fe, Ru and Os.

11. The process as claimed in claim 3, wherein the promoter metal is selected from the group consisting of Al, Zn, Sn, In, Ti, rare earth metals, alkali metals and alkaline earth metals.

12. The process as claimed in claim 1, wherein the active metal precursor A comprises a compound of the formula MeXₚLₒ, where Me is an active metal, X is selected from the group consisting of straight-chain and branched alkyl groups having from 1 to 6 carbon atoms, cycloalkyl groups having from 3 to 8 carbon atoms, alkenyl groups having from 2 to 6 carbon atoms, e.g. an allyl group, aryl groups which have from 6 to 18 carbon atoms and may in turn be substituted by alkyl groups having from 1 to 6 carbon atoms, halogen atoms or amino groups, cyclopentadienyl groups which may be unsubstituted or substituted by one or more alkyl groups having from 1 to 6 carbon atoms, phosphanes, in particular alkylphosphanes having from 1 to 9 carbon atoms; silanes, cyanates and isocyanates having from 1 to 6 carbon atoms, alkoxides (OR*), amides (NR₂*), β-diketonates (R*(═O)CHC(═O)R*) and their nitrogen analogues, in particular β-ketoiminates (R*(═O)CHC(═NR*)R*) and P-diiminates (R*(═NR*)CHC(═NR*)R*), carboxylates (R*COO), oxalates (C₂O₄), nitrates (NO₃) and carbonates (CO₃), where R* is selected from the group consisting of an alkyl radical having from 1 to 6 carbon atoms, an alkenyl radical having from 2 to 6 carbon atoms, and an aryl radical having from 6 to 18 carbon atoms, wherein the radicals R* may be identical or different, p is an integer corresponding to the valence of the active metal, o is an integer from 0 to the number of free coordination sites of the active metal atom and L is a Lewis-basic organic ligand which is selected from the group consisting of oxygen, nitrogen, phosphorus and carbon as ligator atom.

13. A catalyst comprising a porous support having a specific surface area of at least 500 m²/g and at least one active metal or active metal oxide, characterized in that the porous support is formed by an MOF.

14. The catalyst as claimed in claim 13, characterized in that the MOF is formed by at least one metal and at least one at least bidentate ligand.

15. The catalyst as claimed in claim 13, characterized in that the at least one metal of the MOF is selected from the group consisting of Zn, Cu, Fe, Al, Sn, In, and Ti.

16. The catalyst as claimed in claim 13, characterized in that the at least bidentate ligand of the MOF is selected from among compounds of the formula
Z-R^{a}-Z
where Z is selected from the group consisting of a carboxy group, a carbamide group, a hydroxy group, a thiol group, an amino group and a pyridyl group and R^{a} is selected from the group consisting of, 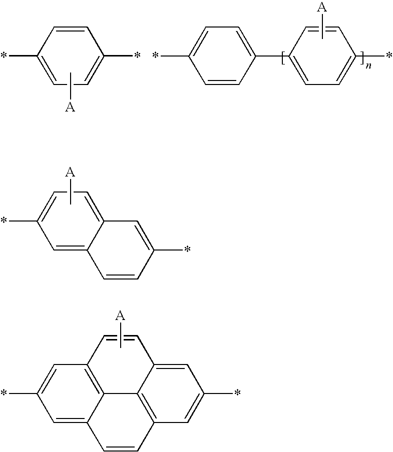
where A represents hydrogen, alkyl groups having 1-6 carbon atoms, alkenyl groups having 2-6 carbon atoms, alkoxy groups having 1-6 carbon atoms and from 1 to 3 oxygen atoms, halogen atoms or amino groups, with A being able to be identical or different on each occurrence and a plurality of groups A also being able to be provided.

17. The catalyst as claimed in claim 13, wherein the degree of loading with the active metal is at least 30% by weight, based on the MOF.

18. The catalyst as claimed in claim 13, wherein the catalyst further comprises at least one promoter metal or promoter metal compound.

19. The catalyst as claimed in claim 13, wherein the active metal has a specific metallic surface area of at least 5 m²/g_{active metal}.

20. The catalyst as claimed in claim 18, wherein the promoter metal has a specific surface area of at least 25 m²/gₚᵣₒₘₒₜₑᵣ.

21. The catalyst as claimed in claim 13, wherein the active metal is incorporated in the form of nanoparticles.

22. The catalyst as claimed in claim 21, wherein the nanoparticles have a size of less than 5 nm.

23. The catalyst as claimed in claim 21, wherein the nanoparticles have a size in the range of 0.1 to 4 nm.
